(19) United States
(12) Patent Application Publication
(10) Pub. No.: US 2006/0240987 A1
(43) Pub. Date: Oct. 26, 2006

(54) Novel agrochemical sulfonamide formulations

(75) Inventor: Charles P. Grasso, Yuma, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Gowan Company, L.L.C., Yuma, AZ (US)

(21) Appl. No.: 11/114,638

(22) Filed: Apr. 26, 2005

(51) Int. Cl. A01N 47/36; A01N 25/12

(52) U.S. Cl. 504/211; 504/367

(57) ABSTRACT

The invention provides agrochemical soil-applied granular compositions including sulfonamide herbicides that are both chemically and physically stable and methods of making and applying these granular compositions.

### BACKGROUND OF THE INVENTION

1. Field of the Invention

The present invention concerns sulfonamide preparations, and, more particularly, agricultural formulations that feature improved stability and desirable application characteristics and include a sulfonamide, such as a sulfonylurea.

2. Description of the Related Art

Sulfonamide herbicides are well known in the art as being highly beneficial for controlling undesirable vegetation in agronomically desirable crops including corn, cereals such as wheat and barley and various perennial crops and a variety of fruit and vegetable crops. Compounds in this class of chemistry are highly active against a wide variety of undesirable vegetation and, depending upon the individual compound, are also selective in crops.

One type of sulfonamide herbicides, the sulfonylurea herbicides, are most frequently formulated as a single product in solid form, such as water dispersible granules, due to their inherent instability in water and organic solvents both alone and in the presence of other chemicals and adjuvants. Therefore, in actual commercial application, sulfonylurea herbicides typically are applied in a spray tank mix combination with another herbicidal agent to increase spectrum of activity or to control weed species that exhibit resistance to ALS herbicides. For example, triallate (S-(2,3,3,-trichloroallyl)-N, N-diisopropylthiocarbamate) is an effective herbicidal agent used for the control of wild oats and selected grasses in a variety of crops including cereals.

However, because sulfonamides are unstable in soluble form, mixtures of different granular and/or liquid agrochemicals must be used in order to provide for broader spectrum of control. Depending on the application rates (i.e., the activity level of the active ingredient) of the different agrochemical agents, it may be difficult to provide the desired level of control unless multiple products are used and/or multiple applications are made. This can increase costs, time spent on control measures, and/or the possibility of a mixing or application error.

### SUMMARY OF THE INVENTION

The invention generally relates to chemically and physically stable granular herbicidal compositions of sulfonamide herbicides. In one aspect, the invention includes a sulfonamide herbicide disposed as a coating upon a granule in order to effect aqueous dispersion with less degradation of the sulfonamide than would occur in solution.

In another aspect of the invention, a “dual or multi action” agrochemical is provided that includes a sulfonamide herbicide, such as sulfonylurea, as a coating on a granule that contains one or more additional agrochemicals, such as triallate alone or in combination with other pesticidal agents.

In another aspect of the invention, methods of preparing novel compositions of the present invention that provide stable granular compositions of sulfonamide herbicidal agents alone and in admixture with other agriculturally beneficial agents, which include, but not limited to, herbicidal agents (including herbicide plant growth regulating agents), insecticidal agents, fungicidal agents, and other pesticides are disclosed. The invention also provides methods for the use of granular herbicides including a sulfonamide in the control of undesirable plants and other organisms.

It is an object of this invention to provide chemically and physically stable soil-applied granular sulfonamide herbicide compositions alone and in combination with other agrochemical agents, such as triallate.

It is another object of this invention to provide a method for preparing granular compositions including a sulfonamide with or without one or more additional agrochemicals.

Further it is an object of this invention to provide a method for controlling a broader spectrum of undesirable vegetation in agronomically desirable crops by application of a single “dual or multi-action” product.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIGS. 1A-1C depict examples of preferred methods for preparation of the invention.

### DETAILED DESCRIPTION OF THE PREFERRED EMBODIMENTS

The invention relates generally to compositions and processes that involve granular compositions of an agrochemical preparation including a sulfonamide herbicide.

Sulfonamide herbicidal agents, such as sulfonylurea, generally posses a high level of activity. Frequently, this high level of activity requires very low application rates of active ingredient in order to avoid over treatment and waste of product. Indeed, many uses of these types of herbicides require application rates in the 2 to 50 gram per acre range. This low application rate (i.e., requirement for low levels of active ingredient) and chemical instability is especially problematic when a producer desires to use a sulfonamide herbicide in combination with additional crop protection chemicals, which typically require higher rates of application. In practice, the use rate ranges of many desirable active ingredients may be as high as the 200 grams to 1,200 grams per acre range. This large difference in use rates requires the preparation of chemically and physically stable compositions containing as low as 0.05% of a sulfonamide on a weight basis.

The preparation of compositions containing low concentrations of one ingredient alone or with high concentrations of one or more other active ingredients has additional requirements of homogeneity and uniformity as well as stability. The requirements of chemical and physical stability are of particular importance when delivering low concentrations in a uniform and consistent manner.

It has been found by the inventor that stable granular compositions containing low levels of one or more sulfonamide herbicides (alone and in combination with other crop protection chemicals requiring higher rates of application) may be prepared by adsorbing the higher use rate chemical on a granular natural mineral or synthetic carrier medium and then coating the adsorbed granular product obtained with a premix containing one or more sulfonamide herbicides.

Additionally, a binding agent and a filler, such as a clay, inorganic salt, or a polysaccharide solid may be combined with the sulfonamide herbicide to improve coating properties. The current compositions are also suitable for applying sulfonylurea and/or another sulfonamide herbicidal agents alone (without a second type of agrochemical agent).

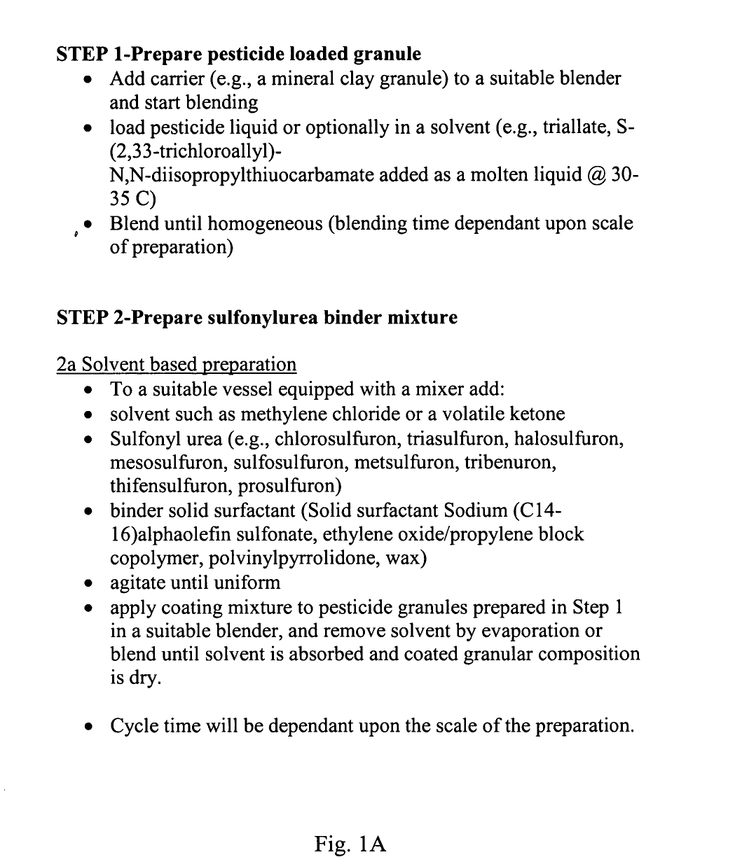

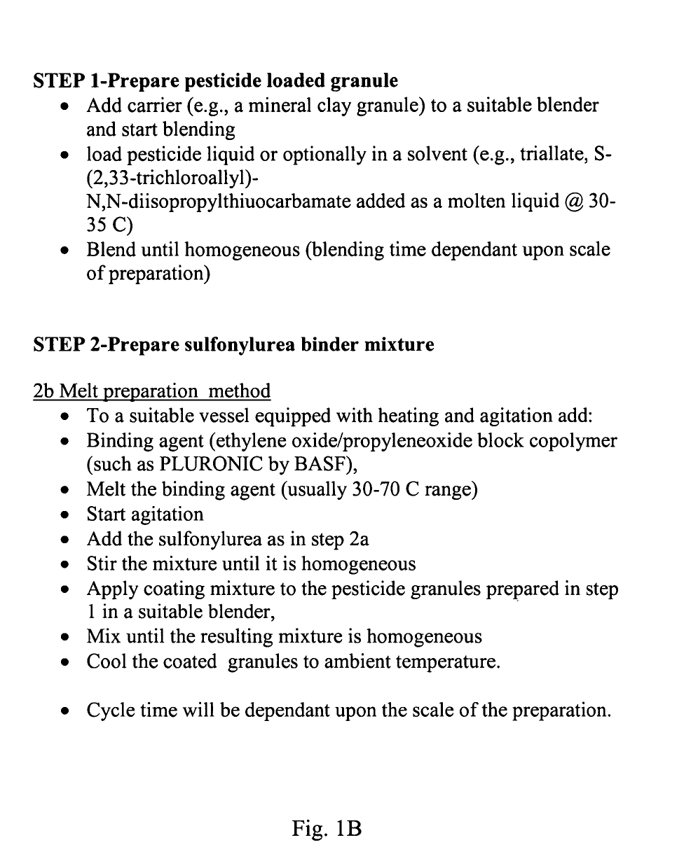

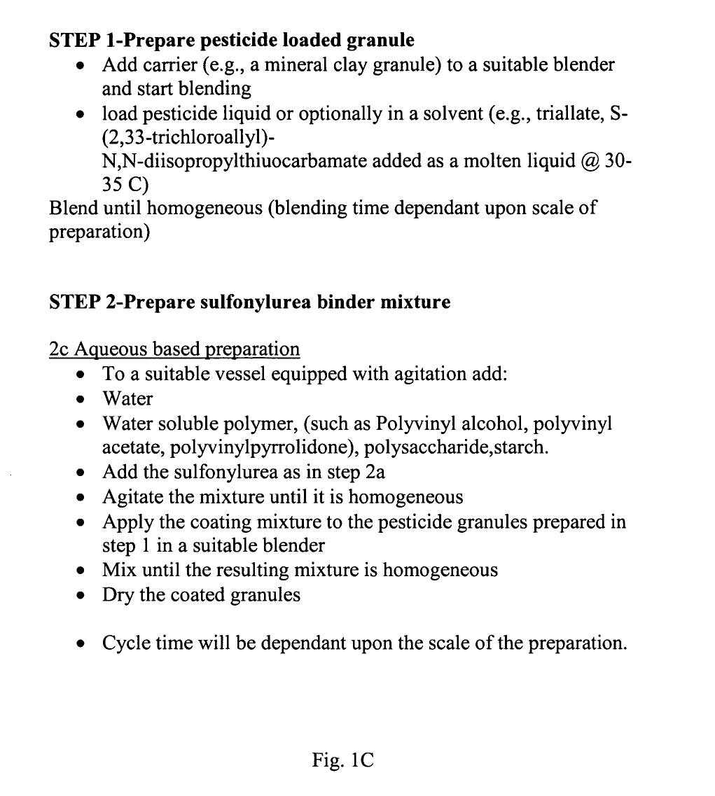

Thus, a barrier may be created between the sulfonamide and other chemicals through the use of coating materials or binding agents that substantially isolate the sulfonamide and limit degradation or reaction, resulting in a physically and chemically stable sulfonamide herbicide composition. FIGS. 1A-1C outline examples of methods for preparing “multi-action” pesticides containing sulfonamide and at least one other agrochemical agent.

The sulfonamide herbicides suitable for use in the compositions of this invention are well known. Many are currently items of commerce and described in patents, such as U.S. Pat. Nos. 4,127,405; 4383,113; 4,394,506; 4,605,433; 4,731,466; and 5,010,195.

Preferred sulfonylurea herbicides for use in the present invention include, but are not limited to: chlorsulfuron, halosulfuron, triasulfuron, mesosulfuron, sulfosulfuron, metsulfuron, tribenuron, thifensulfuron, prosulfuron, and mixtures of two or more thereof. Preferred concentrations for sulfonamide compounds on a weight basis is from about 0.5% to about 50% of the coating composition.

Crop protection agents suitable for use in the compositions of this invention include, but are not limited to, herbicides (including plant growth regulating agents), insecticides, fungicides and other pesticides, fertilizing agents and enhancers, and the like. One especially preferred herbicidal agent for use in these compositions is triallate.

Soil-applied granular carriers suitable for use in adsorbing the higher concentration active ingredient are available commercially and are identified by a variety of names and classifications and include natural and synthetic or processed clays and silicates such as kaolins, montmorillonites, bentonites, and cellulosic processed granules such as Biodac™ (Kadant Grantek). Preferred active ingredient loadings on these granular carriers is normally in the 1% to 25% range, but may be lower or higher depending upon the biological activity of the pesticide and its sorptivity on the granule. Preferred soil-applied granular carriers are commonly described as having U.S. mesh size ranges in the 12/60 range and more commonly in the 24/48 range. Finer granules, sometimes referred to as micro granules, are also suitable.

Binding agents suitable for use in the coating composition include water soluble and water dispersible solid surfactants, waxes, polysaccharides, natural and synthetic starches, polymers such as polyvinyl alcohol, polyvinyl acetates and copolymers, polyvinyl pyrrolidones, and the like.

Preferred ratios of binding agent to sulfonamide range from 1/1 to 20/1, depending upon the sulfonamide being used and the desired final concentration on the coated granule. Higher or lower ratios may, of course, also be employed if required. One suitable list for reference may be found in the North American and International editions of McCutcheon's Emulsifiers & Detergents and Functional Materials (2004 Editions).

Preferred compositions contain 0.05% to 5.0% on a weight basis of a sulfonamide herbicide alone or in combination, 0.05% to 50.0% on a weight basis of a binding agent, and 0.0% to 25% on a weight basis of a second crop protection agrochemical agent adsorbed on 20.0% to 99.0% on a weight basis of granular carrier.

Compositions of the present invention may be prepared in a variety of ways. Soil-applied granules may be prepared by optionally adsorbing a higher use level active ingredient directly on the clay granule or adsorbing as a diluted solution in an appropriate solvent. The coating composition containing the sulfonylurea or sulfonamide may then be prepared by admixing the active ingredient with the desired binding agent, which preferably is chemically inert and which may be in a molten state or in solution or suspension in an appropriate solvent, such as water or an organic solvent or oil, and applying it to the optionally preloaded carrier. The coating mixture may be applied to the preloaded carrier containing the other active ingredient or mixture of active ingredients while blending to obtain a homogeneous coating and then removing the solvent or water by evaporation or absorption of the liquid, cooling, or heat curing.

### EXAMPLES

The present invention is further illustrated by the following non-limiting examples.

### Example 1

### Preparation of a Soil Applied Granule Containing 10% w/w Triallate and 0.28% w/w Halosulfuron.

Preparation of sulfonylurea-coated soil applied granules is performed as follows. Technical triallate, 10% (active ingredient) on a weight basis, is sprayed unto 90% on a weight basis of 24/48 montmorillonite clay granules in a suitable mixer, such as a munson or ribbon blender, while agitating the mixture. Agitation of the mixture is continued until it is homogeneous. The resulting 10% w/w granules are collected and assayed.

The coating mixture is prepared by blending the desired quantity of halosulfuron (4.2 g), one part on a weight basis with four parts (16.8g) on a weight basis of a Sodium (C14-16) alpha olefin sulfonate, such as WITCONATE AOK (Akzo Nobel), and milling or grinding the mixture until it is homogeneous.

The 10% triallate granules, (1.5 kg), are added to a suitable mixer. Agitation is initiated, and the coating mixture prepared above is suspended in methylene chloride (75 mL) and sprayed onto the granules. The methylene chloride is removed by evaporation and the coated granules collected and assayed, giving a combination granule containing triallate, 10.72% w/w and halosulfuron 0.28% w/w.

### Examples 2-9

### Utilizing the Procedure as Described in Example 1 Yields the Coated Granules Listed in Table I Below:

TABLE I
Herbicidal Sulfonylurea Coated Triallate Granules

| Sulfonylurea | % W/W | Assay % W/W | Triallate Assay % W/W |
|---|---|---|---|
| 2. Chlorsulfuron | 0.08 | 0.09 | — |
| 3. Chlorsulfuron | 0.108 | 0.11 | 10.36 |
| 4. Chlorsulfuron | 0.154 | 0.17 | — |
| 5. Triasulfuron | 0.108 | 0.11 | — |
| 6. Triasulfuron | 0.148 | 0.15 | 10.58 |
| 7. Triasulfuron | 0.174 | 0.19 | — |
| 8. Halosulfuron | 0.216 | 0.19 | — |
| 9. Halosufuron | 0.233 | 0.21 | 10.72 |

### Example 10

### Stability Evaluation

A sample of combination composition prepared in Example 1, containing 0.28% w/w of halosulfuron, above was placed in a sealed foil lined bag and stored at ambient temperature (22-28 C) for twenty weeks replicated workup, extraction and assay resulted in essentially quantitative recovery of halosulfuron (0.28% w/w).

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products. All references cited in this application are hereby incorporated by reference herein.

What is claimed is:

1. An agrochemical composition, comprising a sulfonamide herbicide disposed as a coating upon a soil-applied granule.

2. The composition of claim 1, wherein said sulfonamide herbicide comprises a sulfonylurea.

3. The composition of claim 1, wherein said granule contains between 0.05% to 5% on a weight basis of the sulfonamide, which is adhered substantially uniformly upon each granule.

4. The composition of claim 1, wherein:
said granule further includes a second agrochemical agent; and
a barrier ingredient separates said second agrochemical agent from said sulfonamide herbicide.

5. The composition of claim 4, wherein said barrier ingredient is a chemically inert coating material.

6. The composition of claim 4, wherein said second agrochemical agent is selected from the group consisting of a pesticide or fertilizer.

7. The composition of claim 1, further including a binding agent.

8. The composition of claim 4, further including a binding agent.

9. The composition of claim 7, wherein the binding agent is water soluble or dispersible and selected from the group consisting of a polysaccharide, a starch, a polymer of polyvinyl alcohol, a polyvinyl acetate or copolymer thereof, a polyvinyl pyrrolidone, and a solid surfactant or wax.

10. The composition of claim 4, wherein said second agrochemical agent comprises 5% to 25% on a weight basis of S-(2,3,3-trichloroallyl)-N,N-diisopropylthiocarbamate.

11. The composition of claim 1, wherein said sulfonamide herbicide is present in the amount of 0.04% to 1.0% on a weight basis and is selected from the group consisting of halosulfuron, triasulfuron, chlorosulfuron, mesosulfuron, sulfosulfuron, metsulfuron, tribenuron, thifensulfuron, and prosulfuron.

12. The composition of claim 4, wherein said sulfonamide herbicide comprises 0.04% to 0.16% on a weight basis of chlorsulfuron and said second agrochemical agent comprises from 10% to 20% on a weight basis of S-(2,3,3-trichloroallyl)-N,N-diisopropylthiocarbamate.

13. The composition of claim 4, wherein said sulfonamide herbicide comprises from 0.5% to 0.2% on a weight basis of triasulfuron and said second agrochemical agent comprises from 10% to 20% of S-(2,3,3-trichloroallyl)-N,N-diisopropylthiocarbarnate.

14. The composition of claim 4, wherein said sulfonamide herbicide comprises from 0.1% to 0.4% on a weight basis of halosulfuron and said second agrochemical agent comprises from 10% to 20% of S-(2,3,3-trichloroallyl)-N,N-diisopropylthiocarbamate.

15. The composition of claim 4, wherein said sulfonamide herbicide comprises from 0.1% to 1% on a weight basis of sulfosulfuron and said second agrochemical agent comprises from 10% to 20% S-(2,3,3-trichloroallyl)-N,N-diisopropylthiocarbamate.

16. A method for the preparation of a multi-action soil-applied granular composition containing a sulfonamide herbicide, comprising the steps of:
(a) loading a first agrochemical agent into the soil-applied granular composition; and
(b) coating the soil-applied granular composition with a sulfonamide herbicide.

17. The method of claim 16, further including the step of blending said soil-applied granular composition until it is substantially uniformly coated.

18. The method of claim 16, wherein the sulfonamide herbicide of step (b) further includes a premix of binding agent as a solution or suspension in a solvent and said solvent is removed by evaporation or absorption following step (b).

19. The method of claim 16, wherein said first agrochemical agent comprises a pesticide that is used at a higher rate than said sulfonamide herbicide.

20. The method of claim 16, wherein said soil-applied granular composition comprises a natural mineral or synthetic granule.

21. The method of claim 16, wherein said sulfonamide herbicide comprises a sulfonylurea.

22. The method of claim 18, wherein said soil-applied granular composition comprises on a weight basis from 0.05% to 5.0% of said sulfonamide herbicide, from 0.05% to 50% of said binding agent, and from 0.0% to 25% of said first agrochemcical agent adsorbed on 20% to 99% of said granular composition.

23. The method of claim 18, wherein the binding agent is water soluble and selected from the group consisting of a polysaccharide, a starch, a polymer of polyvinyl alcohol, a polyvinyl acetate or copolymer thereof, a polyvinyl pyrrolidone, and a solid surfactant or wax.

24. The method of claim 16, wherein said first agrochemcial agent is a pesticide or fertilizer.

25. The method of claim 24, wherein the pesticide comprises S-(2,3,3,-trichloroallyl)-N,N-diisopropylthiocarbamate.

26. The method of claim 21, wherein the sulfonylurea is selected from the group consisting of chlorsulfuron, triasulfuron, halosulfuron, mesosulfuron, sulfosulfuron, metsulfuron, prosulfuron, or a mixture thereof.

27. A method for the control of undesirable vegetation in agronomically desirable crops, comprising the step of applying to a locus of said crops a soil-applied granular composition coated with a sulfonamide herbicide.
